(19) United States
(12) Patent Application Publication
(10) Pub. No.: US 2008/0048376 A1
(43) Pub. Date: Feb. 28, 2008

(54) Plastic products containing images and methods of manufacture related thereto

(76) Inventors: Steven S. Farmer, Mooresville, NC (US); Barry R. Dailey, Davidson, NC (US)

Correspondence Address: KILPATRICK STOCKTON LLP, 1001 WEST FOURTH STREET, WINSTON-SALEM, NC, 27101, US

(21) Appl. No.: 11/881,569

(22) Filed: Jul. 27, 2007

Related U.S. Application Data
(60) Provisional application No. 60/833,704, filed on Jul. 27, 2006.

(51) Int. Cl. B23Q 3/00; C09J 163/00

(52) U.S. Cl. 269/289 R; 156/277; 156/330; 264/132; 264/238; 264/241

(57) ABSTRACT

The present invention relates to plastic products containing images, and for methods of manufacturing said plastics containing images. In a variation, the invention relates to plastic cutting boards, and the manufacture of plastic cutting boards. The cutting boards may be manufactured to contain anti-bacterial properties and provide a non-slip cutting surface. Embodiments of the present invention may be manufactured in a variety of shapes and sizes and may feature different colors or images.

### RELATED APPLICATIONS

This application claims priority under 35 USC §119(e) to U.S. provisional application 60/833,704 filed Jul. 27, 2006.

### FIELD OF THE INVENTION

The present invention relates to plastic products containing images and methods and processes of adding these images to these products. Embodiments of the present invention are particularly useful for providing a cutting surface containing these images. In a variation of these embodiments, the cutting board provides for a decorative, non-slip cutting surface.

### BACKGROUND OF THE INVENTION

Alexander Parkes first demonstrated plastics at the 1862 Great International Exhibition in London. The material called Parkesine was an organic material derived from cellulose that, once heated, could be molded and retained its shape when cooled. With this initial introduction of plastic by Alexander Parkes, mankind recognized the usefulness of plastics, and plastic products have been made to an ever expanding extent to generate useful products to the trillion dollar industry that plastics are today. New and better plastics are still being developed.

Plastic products that have been made include cutting boards, countertops, other kitchen plastic products, as well as a plurality of other products made from plastic. Cutting boards of polypropylene and polyethylene have been shown to be useful as they can be made inexpensively. However, these plastic products tend to have the drawback of not being aesthetically pleasing. People have attempted to add color to these plastic products, such as cutting boards, which has made these plastic products slightly more aesthetically pleasing, but they still lack artistic qualities. To date, to the inventors knowledge, no plastic products, and in particular, no plastic cutting boards have been developed that contain images associated with them.

Plastic cutting boards have primarily been used in kitchens to provide a surface for preparing both hot and cold foods. Conventional plastic cutting boards have traditionally been favored for their low cost; however, they are not aesthetically pleasing and are not suitable for display on a kitchen counter. For this reason, some consumers have favored wood cutting boards. While wood cutting boards are more aesthetically pleasing, they lack the ease of cleaning that a plastic surface provides since they must be hand washed and dried. Conventional plastic cutting boards may also be thin and thus may be easily scarred by repeated use. Because conventional plastic cutting boards are often white, the scarring is visible and the board must be frequently replaced. Another disadvantage of some conventional plastic cutting boards is that the plastic may warp under high temperature and thus they cannot be cleaned by placing it in dishwasher. Conventional plastic cutting boards also may not contain a non-slip surface making it difficult to prepare foods without the cutting surface moving on the countertop. Since conventional plastic cutting boards are often thin and cheap they do not provide good shock absorption for the user or for the utensils used in the food preparation. The lack of shock absorption creates more stress on the user and may contribute to a faster wearing down of the knife or other utensil used in food preparation. Conventional plastic cutting boards can easily be cut by food preparation utensils, such as sharp knives. Once the plastic surface has been cut by the knife it creates a crevice in which bacteria can grow. In many cutting boards, the surface is so thin it can be difficult to remove the bacteria once the surface has been scarred by many small cuts. The bacteria may collect in the small crevices and it is difficult to reach with conventional cleaning tools. Thus the cutting board becomes less sanitary for use in food preparation. Many conventional plastic and wood cutting boards only come in square or rectangular shapes. These shapes may not be useful for cutting foods of different shapes, such as round pizzas.

Thus, there is a need for a cutting board that is aesthetically pleasing, yet is cost effective, and is available in a variety of shapes to accommodate different types of food preparation tasks.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a front view and 1B is a back view of the cutting board.

FIGS. 1C and 1D are cross sectional areas of the cutting board.

FIG. 2A is a front and 2B is a back view of the cutting board highlighting the corner non-slip features of the cutting board which display a writing on the cutting board.

FIGS. 2C and 2D are blow up figures of the non-slip corners.

FIG. 3 is a perspective view of the cutting board showing the back side of the cutting board, showing the non-slip corner pieces and a trough to collect liquid or other food products that may be generated, for example, during food preparation.

FIG. 4 is a side view of the cutting board showing the non-slip corner pieces.

FIG. 5 is a view of the corner non-slip piece of the cutting board displaying the name of the product.

FIG. 6 is a view of the front side of the cutting board displaying an image of grapes and an opening at the top of the board for ease of handling, also with details regarding the placement of the image on the surface.

FIG. 7 is a perspective view of the front side of the cutting board displaying an image of a crab with the non-slip corner pieces and a non-slip border around the edge of the board.

FIG. 8 is a perspective view of the cutting board in which the shape is oval and the board is printed with an image of fruit and contains an opening for ease of handling.

FIG. 9 is a view of the front side of the cutting board displaying an image of fruit and an opening at the top of the board for ease of handling, also with details regarding the placement of the image on the surface.

FIG. 10 is a view of the front side of the cutting board displaying an image of writing and an opening at the top of the board for ease of handling, also with details regarding the placement of the image on the surface.

### DETAILED DESCRIPTION

The present invention contemplates a cutting board comprising at least one image, wherein the cutting board is made of any of a plurality of plastics, polyethylene, polypropylene or combinations thereof. The cutting board may also contain at least one image generated by one or more printing techniques such as offset lithography, thermography, reprographics, screen printing, flexography, or gravure. The cutting board may have a laminated surface under which the image appears. In alternate embodiments the image may be applied in the reverse direction such that it can be seen through the other side of the cutting board in the correct orientation. The laminated surface may be attached to the cutting board by a plurality of adhesives, such as glue or epoxy. The cutting board may be any of a variety of shapes including square, round, rectangular, oval or asymmetrically shaped. The cutting board may also contain a non-slip perimeter comprised of one or more of a thermoplastic rubber, thermoplastic resin, thermoplastic elastomer, or thermoplastic vulcanite. Alternatively, the non-slip material may be present at other locations on the cutting board. The cutting board may also contain a laminate that is made of acrylic. In alternate embodiments, the cutting board may contain the image on the laminated surface. The cutting board may be made by any of a plurality of methods including manufacturing a base of the cutting board by press molding; applying an image to a polypropylene sheet by offset printing or screen printing; adhering the polypropylene sheet containing the image to the base of the cutting board.

In a variation of this method, the cutting board may also include a method for adding a rubber border. The manufacture of the cutting board may include using polypropylene or polyethylene. The method of manufacture may optionally include press molding pellets of polypropylene or polyethylene. In a variation of this method, the mold for making the press molding may also include a depression channel that serves as a drip channel. The method of manufacture may also optionally include a method for adhering the polypropylene sheet containing the image to the base of the cutting board by epoxy, contact cement, or glue. The method may also comprise a method for applying the image to the board by screen printing or offset printing.

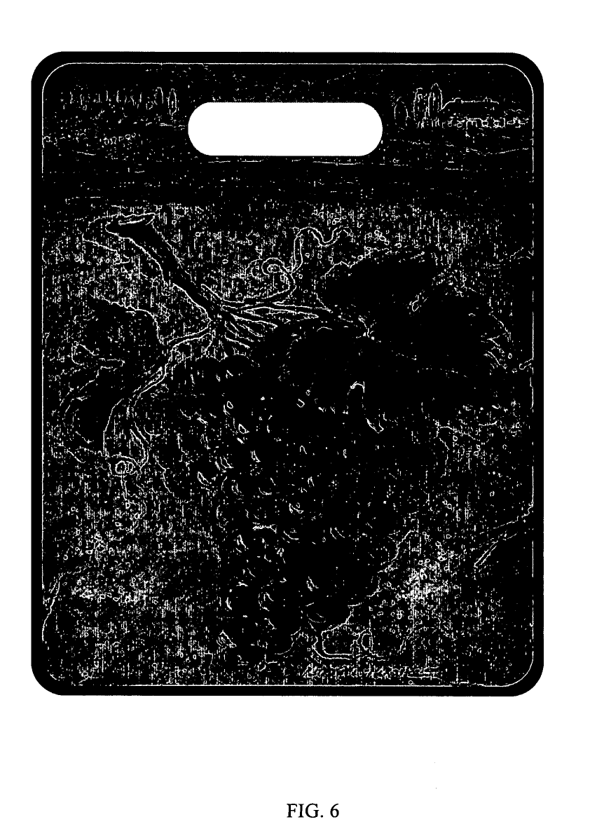

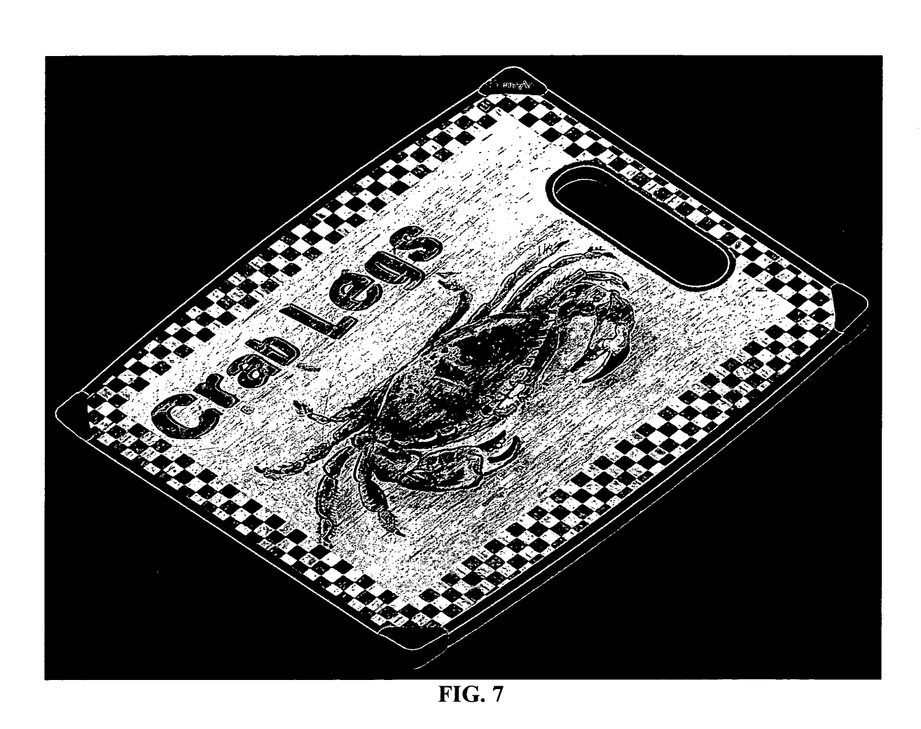

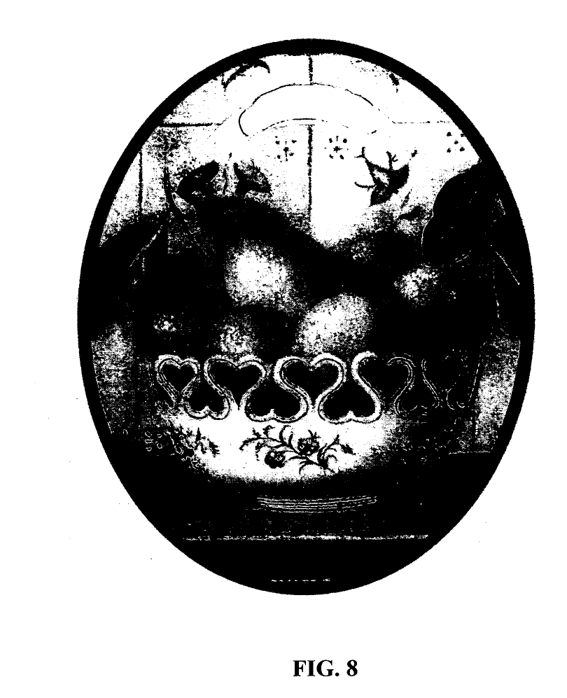

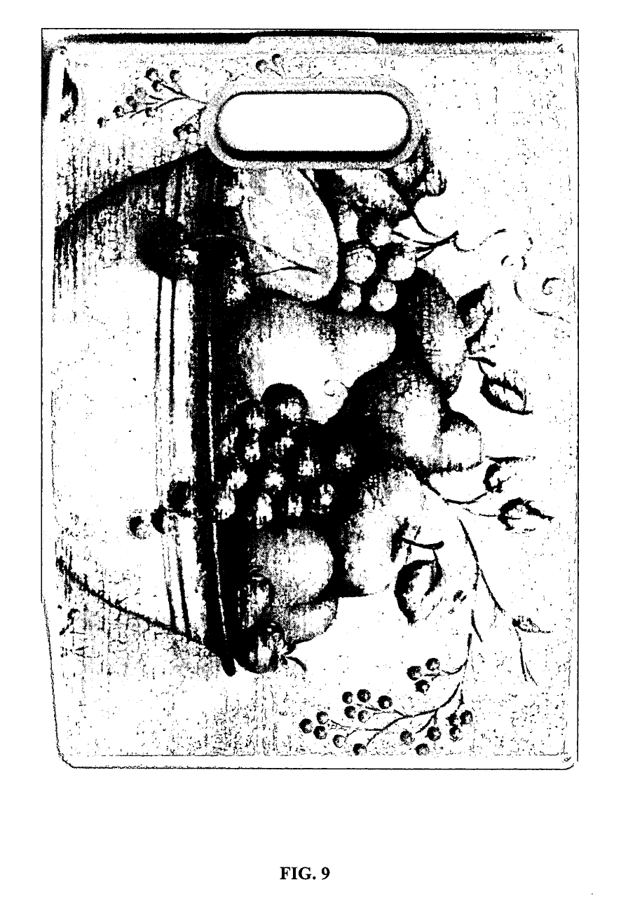

In other embodiments, the present invention relates to plastics containing images. In an embodiment, the present invention relates to plastic cutting boards containing images, as shown in FIGS. 6-8. In a variation, a decorative plastic cutting board includes a decorative image and/or design on one or both sides that is protected by a clear surface of varying thickness. The surface can be any of a number of surfaces as long as the surface is at least partially transparent so that the design and/or image can be visualized by a user of the cutting board. The surface thickness can be from 1 mm to 20 mm in thickness. If the surface is partially opaque, the surface thickness should be sufficiently thin so that the image and/or design can be visualized. The surface should also be sufficiently thick so that the image and/or design is not affected when cuts are made into the board.

It is desired that the design and/or image show through the clear surface but yet be protected from cutting or abrasions. Surfaces that can be used include but are not limited to polymer surfaces such as acrylics, various laminates, polypropylenes, polyethylenes, methacrylic polymers, polycarbonates, polystyrenes, cyclic olefinic polymers, fluoropolymers, polyesters, polyarylates, polysulfides, polysulfones, other sulfur containing polymers, polymethylpentene polymers, polyolefins polymerized with a metallocene catalyst, polyolefins, allylester polymers, polyamideimid polymers, fullerene polymers, propylene-ethylene copolymers, other copolymers, and other transparent polymers or combinations thereof. Glass surfaces can also be used such as tempered glass, heat strengthened glass, laminated glass, quartz, and other types of transparent glasses. Optionally, the cutting board may contain both a polymer and a glass surface, with the caveat that they both be somewhat transparent.

In an embodiment, the surface that is used is resistant to relatively high temperatures and to aqueous solutions so that the board can withstand washing in hot water, such as in a commercial or non-commercial dishwasher without bending and/or warping, and/or peeling and/or chipping and/or cracking of the surface or the underlying base board. Moreover, in a variation, the cutting base board and the transparent surface are also durable so that when cuts are made, the design and/or image is not affected. Further, in an optional embodiment, the cutting board is also acid and base resistant so that the surface and/or the base board does not corrode or disintegrate when exposed to alkaline or acidic environments. In a variation of an embodiment, the cutting board may be resistant to UV light so that it does not break down upon UV exposure (such as with exposure to direct sunlight). In a further embodiment, the cutting board is resistant to bleaches or other cleaning materials. In a variation, the cutting board surface is also relatively scratch proof and be resistant to scratching due to cleaning with abrasive surfaces, such as steel wool or other abrasive cleaners.

The plastic base cutting board can be made from any of a plurality of substances, such as polypropylene, polyethylene, including high density polyethylene boards such as SANATEC® (Compression Polymers, Corp. and Vycom, Corp., Scranton, Pa.) plastics or high density propylene plastics, polyvinyl chlorides (PVC), polyvinyl carbonates, acrylics, TEFLON® (DuPont, USA) copolymers, such as a copolymer of polypropylene and polyethylene and other durable polymers or combinations thereof. The plastic cutting board can also be present in any of a number of colors, which may affect the way the design and/or image associated with the cutting board appears. For example, SANATEC® plastics can be used, which can have colors added to them with different colors being used for different food products. For example, a light green SANATEC® plastic can be used to cut vegetables, which in a variation of this embodiment contains an image containing for example, green beans (that may be darker in color so that they can be visualized on the light green background) or any other vegetable. It should be recognized that any image can be used in the present invention including but not limited to photographic images, drawings, holographic images, etched drawing images, electronic images, non-electronic images and any other image(s).

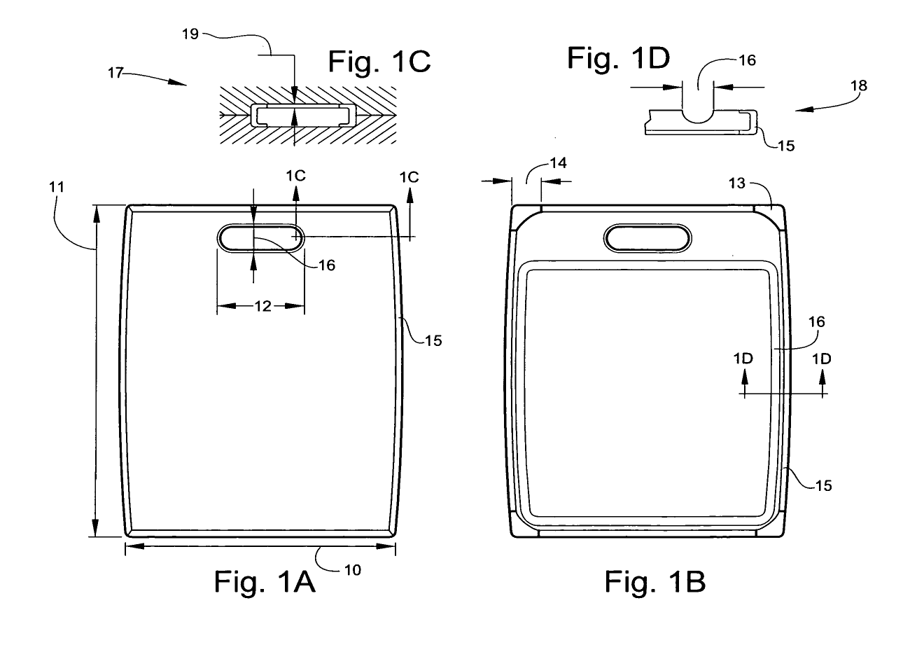

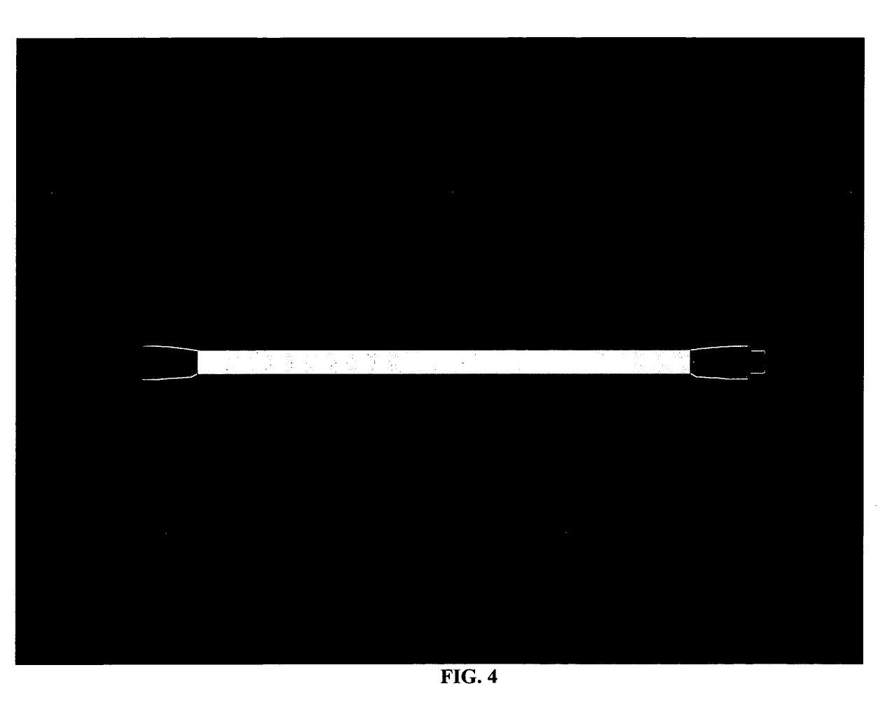

In an embodiment of the invention, the cutting board containing the image contains a non-slip border around the cutting board, as shown in FIGS. 1-4. This non-slip border can be made of any of a plurality of materials including but not limited to thermoplastic rubbers, other thermoplastic resins (TPR), thermoplastic elastomers (TPE), thermoplastic vulcanites (TPV) or combinations of any of the above. The non-slip border provides an advantage over conventional plastic cutting boards in that it provides non-slip contact points between a cutting board and a kitchen counter surface or some other surface. Although, a cutting board is described with a non-slip border, it should be understood that the non-slip materials can be at any location on the cutting board.

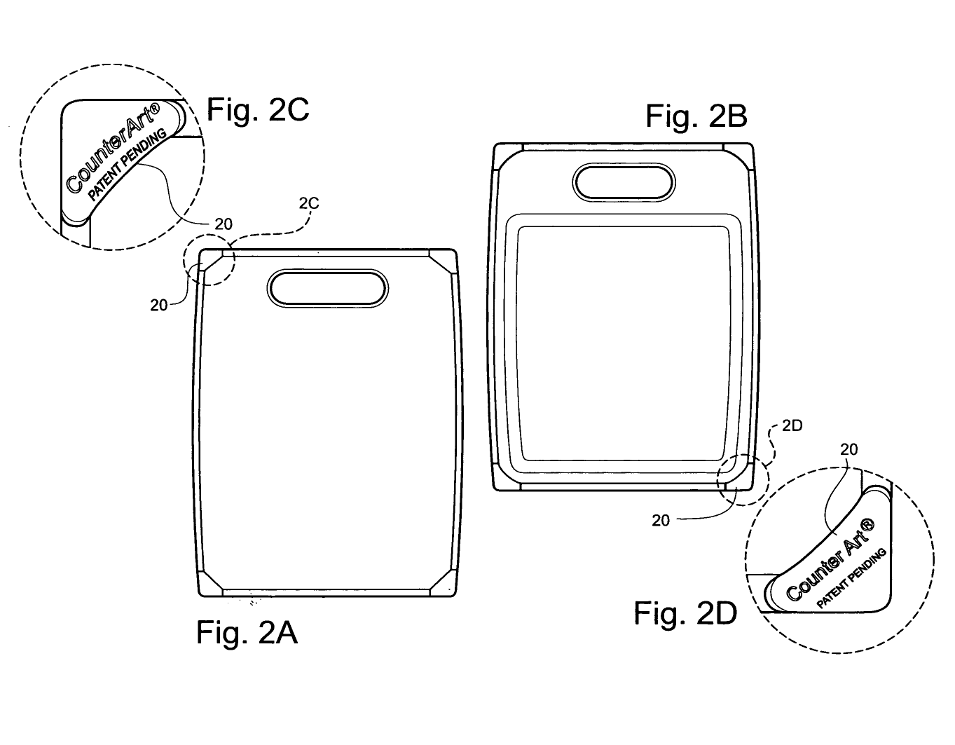

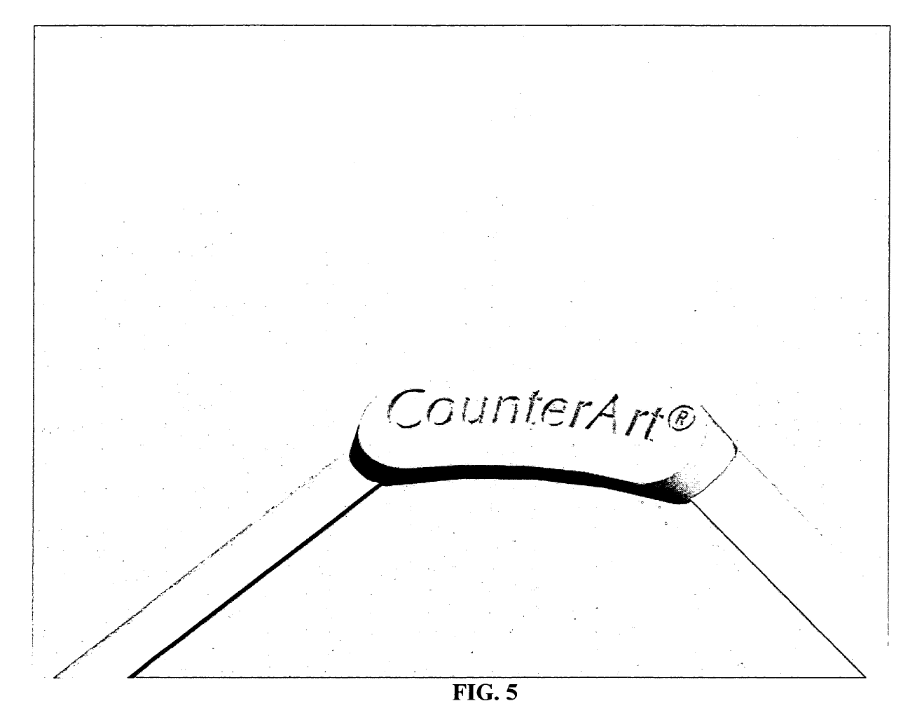

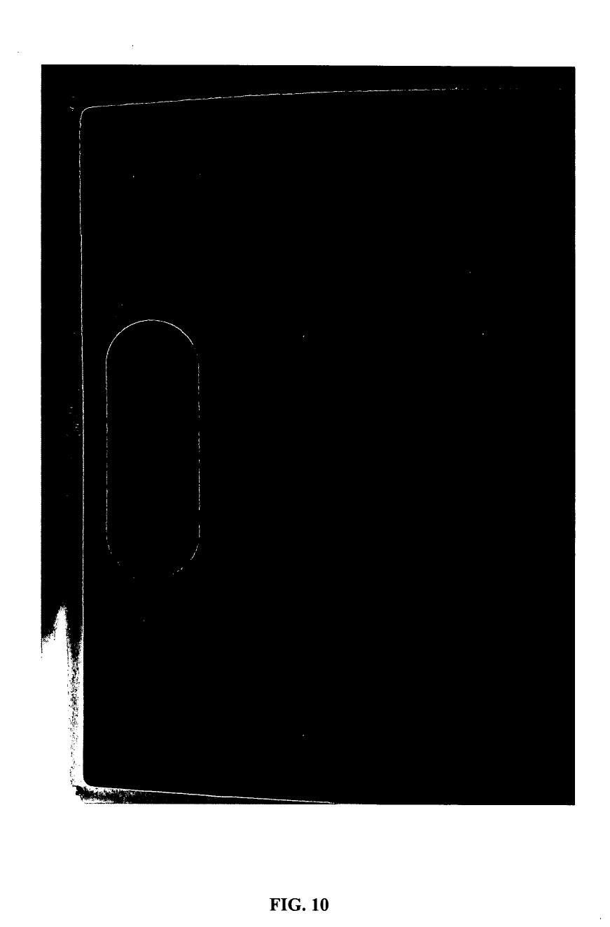

In FIGS. 1A and 1B, 10 represents the width of the cutting board, which in this variation may be between about 270 to 310 mm. In a variation, the width is about 285 mm. 11 represents the length of the cutting board, which may be between about 365 to about 390 mm. In a variation, the length is about 378 mm. 12 represents the length of a handle hole. In an embodiment, this length may be between about 85 to 95 mm. In a variation, the length of the handle hole may be about 90 mm. 16 represents the width of the handle hole and in an embodiment may measure about 20 to about 30 mm. In a variation, the width of the handle hole is about 25 mm. 15 shows the border which in this instance may be any of a plurality of rubbers or other similar materials. 13 represents a corner edge piece with non-slip properties. This corner edge piece may have writing on it as shown by 20 in FIGS. 2C and 2D. 16 represents a trough that can collect liquids. In this figure, the trough is shown on the back of the cutting board (the side opposite the image). However, it should be understood that the present invention encompasses the trough on the same side as the image. Please note that the trough may not be present as demonstrated in FIG. 1C. The trough on the back side of the cutting board (wherein one can also cut food) can also be seen in FIG. 5. One can cut on either side of the cutting board.

In FIGS. 1C and 1D, 17 and 18 represent section cutaway views of various parts of the cutting board. In the section cutaway view that is represented by 17, one can see the width of the laminate 19 that appears on the plastic cutting board. This thickness can vary between about 1 mm to about 20 mm in thickness. In a variation, the thickness is about 1 mm thick.

In an embodiment of the present invention, a design and/or image is applied by using a type of printing such as offset printing or screen printing to the underside of the surface and then the surface is laminated to the base. Alternatively, images may be added by offset lithography, thermography, reprographics, screen printing, flexography, or gravure. In an embodiment, the design and/or image is printed onto the base and then one or more of the transparent polymer or glass surfaces (or combinations thereof) listed above is attached (by lamination or some other means such as glues, epoxies, contact cements or other attachment means or a combination of these) to the base board containing the image. In a variation of this embodiment, the transparent polymer is acrylic and it is attached to a rigid thicker polypropylene base. Examples of such images are shown in FIGS. 6-8.

In another embodiment of the present invention, the design and/or image may be applied to the cutting board in a negative or reversed manner. When applied in a reversed manner and the image is viewed through the plastic from the opposite side, it will appear in the right orientation. In such an embodiment, it is desired that the plastic be transparent in nature such that the image can be clearly viewed through the plastic. This provides the advantage that the image can be seen and will not be affected by repeated use or cleaning.

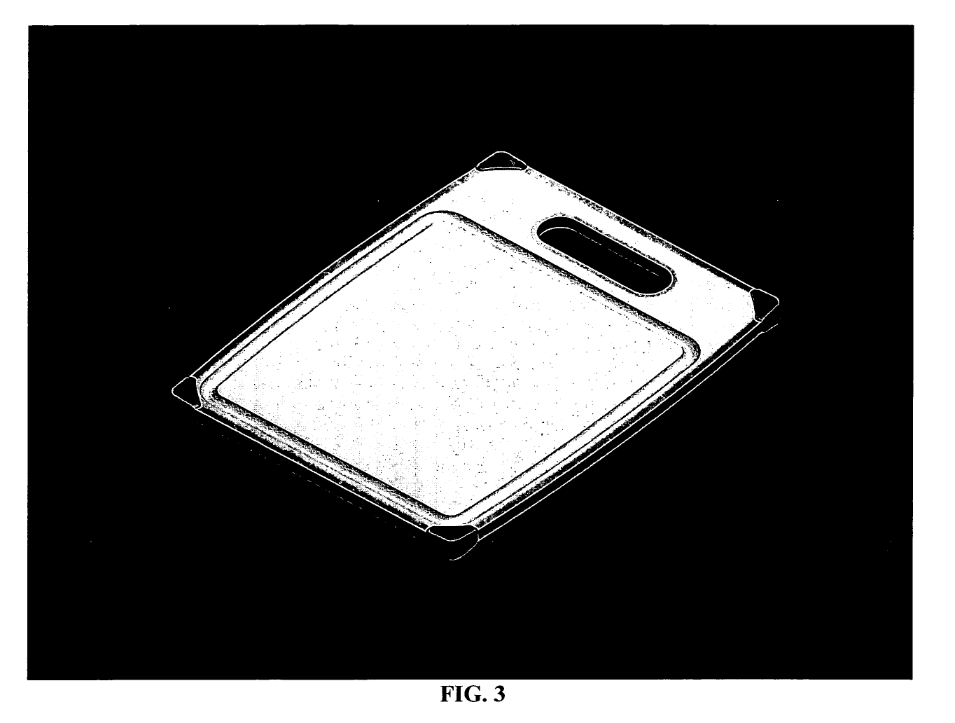

In a further variation of this embodiment, the perimeter of the cutting board has added to it a non-slip perimeter or corner edge pieces with non-slip properties that is made up of a rubberized compound such as TPR, TPE or TPV that is injected into the mold thereby creating a watertight seal and non-skid feature. Exemplary embodiments of this aspect of the invention are shown in FIGS. 1-4. It is contemplated and therefore within the scope of the invention that the non-slip surface can be added to the cutting board so that the non-slip surface is not around the perimeter of the board but rather it is attached to the cutting board in other places, for example, as shown in FIGS. 3-5. In this embodiment, there may be one or a plurality of locations where the non-slip surface can be added to the cutting board to prevent slippage.

In an embodiment of the present invention, the molding of the cutting board may occur by injection molding or by extrusion molding of the polypropylene or other plastic material into desired shapes. It is contemplated that other molding methods can be used in the present invention. The cutting board will be dishwasher safe making it easy to clean, yet at the same time remain hygienic.

In another embodiment of the present invention, an anti-bacterial or anti-microbial agent may be incorporated into the plastic either at the time of manufacture or to the surface of the board to prevent bacterial growth and encourage a sterile food preparation environment. Examples of anti-bacterial agents that may be incorporated into the polyproplyene cutting board include, for example triclosan or Microban® (Microban International, Ltd., Huntersville, N.C.) and other non-toxic antimicrobial agents that are known to those of skill in the art, or combinations thereof. While these agents are known to reduce the presence and number of bacteria, they are non-toxic to humans when added to the cutting surface.

In an embodiment of the invention, the cutting board can be manufactured in different shapes. Such shapes include, but are not limited to, square, rectangular, oval, round, or even amoebic type non-symmetrical or asymmetrical designs. The different shaped cutting boards can be used to accommodate different types of foods, such as round pizzas or to create a more interesting visual effect.

In another embodiment of the present invention, the plastic cutting surface may serve as all or a portion of a countertop or alternatively, may serve as the countertop itself. To the inventors' knowledge, no countertops with images are known. The board alternatively may be manufactured in a different size or shape to be used as a cheese board. The plastic board may also be used as a trivet to place warm food items on it in order to protect countertops or other kitchen furniture. In this embodiment a plastic with a higher melting temperature is desirable, such as melamine plastics. In another embodiment, the plastic board may serve as a decorative tray for serving foods. Alternatively, the board may serve a decorative function in the home by being placed on the wall. It is also contemplated that in applying the image to plastic technology, one may use any generated product comprising an image as art work placed on a wall or other location outside, thereby providing artwork that is waterproof.

In an embodiment of the present invention, the board may be comprised of raw polypropylene, in pellet form, which is heated to melting temperature and then formed into the body of the board through the use of a press mold. The mold may be altered to accommodate different shapes for the final board product. In a variation of the embodiment, the polypropylene body of the board may have a finished size of width 7 mm thick (although other widths are contemplated and are considered to be within the scope of the present invention), with a trough surrounding the edge of the board to serve as a drip channel for catching liquid that is released during the preparation of either hot or cold foods. The variation above has been described as having a trough, however it is contemplated and within the scope of the invention that the cutting board may be made without a trough. A polypropylene sheet of approximately 1 mm thickness may have an image applied to it by either screen or offset printing. Alternatively, the image may be placed on the polypropylene sheet by gravure printing with normal off-set ink.

In an embodiment, the application of the image to the polypropylene (or polyethylene) sheet may include a method by which the image is etched onto the surface of a metal plate, the etched area may then be filled with ink, then the plate rotated on a cylinder that transfers the image to the polypropylene sheet or any of a plurality of other materials. If the image is transferred onto other materials, it may then be transferred onto the polymer sheet.

The polypropylene (or polyethylene, etc.) sheet may then be laminated to a 7 mm poly-board utilizing an adhesive formulated to withstand dishwasher temperatures. The adhesives may be any of a plurality of adhesives including, but not limited to, glue, epoxies, contact cement, tape, silicone glues, rubber cements, plastic glues, other adhesives or mixtures thereof. Alternatively, the polypropylene sheet can be added to the poly-board by fusion molding the two parts together. In an embodiment, this can be achieved by molding the parts together at the melting point of one or the other part. It is desirable that the image and any inks associated therewith be resistant to the heat necessary to achieve melting. It is contemplated and therefore within the scope of the present invention that reduced pressure may be used to allow melting (thereby reducing the melting temperature of one of the plastics) of the polypropylene or poly-board yet at the same time prevent any degradation that may occur to the inks.

The laminated board can then be placed into an injection mold and a rubber border made of thermoplastic rubber or thermoplastic vulcanite can be injected into the mold thereby forming a contrasting and/or coordinating colored rubber border. In another embodiment of the invention, the rubber border incorporates raised corner sections designed to be the first points of contact when a board is placed on a kitchen counter or other surface.

A further embodiment of the present invention employs a rubber contact point that may be on the perimeter of the cutting board such that the rubber contact point partially or completely encircles the perimeter. In a variation, the rubber contact point may be one or more interior contact points. For example, the cutting board may have one or more holes present in the cutting board wherein one or more rubber plugs are inserted into these holes allowing the rubber plugs to make contact with the surface on which the cutting board is disposed. These holes can be any shape including but not limited to circular, rectangular, square, polygonal, triangular, elliptical, asymmetric, or any other shape. In an embodiment, more than one rubber plug is used so that the cutting board does not wobble when disposed on a surface. The more than one rubber plug also allows the cutting board to sit parallel to the surface on which the cutting board is disposed.

In an embodiment of the present invention, either the printed or non-printed side of the cutting board shown in FIG. 1 may be utilized as a cutting surface. One or both surfaces of the cutting board may contain a trough to collect liquids or other food particles generated during the preparation of the food. A plurality of different cutting boards may be present in a household with ones that are especially suited (with troughs) for food preparation when liquid will be generated. The trough feature, as shown in FIGS. 1-3 provides an advantage over conventional cutting boards in that the liquids are collected in a trough and will not run off of the cutting board when it is moved from one area to another. The trough may also be used to keep other food particles separate from other food (for example, separating fat from meat). The trough can also be used to prevent round food products from rolling (for example, if one is preparing a fruit salad with grapes). The printed side of the cutting board, as shown in FIGS. 1-2 and 6-8 is aesthetically pleasing and may be utilized when it is desired that the food also be presented on the board.

In other embodiments, the cutting board may be manufactured in a number of sizes to accommodate different kinds and sizes of foods. The cutting board may be small to accommodate single portions or larger to accommodate larger food preparation needs. The cutting board may be greater in width in proportion to the length if a different shaped surface area for cutting is desired. Likewise, the cutting board may be of a narrow width as compared to the length if such dimensions are needed. Accordingly, the cutting board may have a thickness that is between 5-20 mm or alternatively, between 7-15 mm or any other thickness.

### EXAMPLE

Pellets of polypropylene or polyethylene are melted and the polyethylene or polypropylene are press molded into a form to generate a base board (a white base board). Glue is applied on top of the base board and on the back of an acrylic flexboard containing an image that is generated by offscreen or gravure printing. The image containing flexboard and base board are then laminated together using glue, and any excess is trimmed from the edge. The combined flexboard and base board is placed in an injection mold and thermoplastic resin edge/rim is injected into the mold and pressed onto the base board (which has the flexboard containing the image attached to it) to generate a laminated board comprising an image with a thermoplastic resin non-skid border.

It is contemplated and considered to be within the scope of the instant invention that any feature of the present invention can be combined together with any other or combination of features. The instant invention is directed to products, methods, and processes wherein images can be added to plastics. Any of the features discussed in this application can be a feature in any claimed product, method, and process. Thus, it should be apparent to those of skill in the art that the instant invention is not to be limited by the exemplary embodiments but is rather to be defined by the following claims. When a method is indicated in the below claims, it should be understood that the steps in the method can be arranged in any order. Further, any time that a range is disclosed it should be understood that any real number value in the range is a potential endpoint, even if that real number potential endpoint is not specifically disclosed. For example, if a range of 7-15 mm is given, it should be understood that a range of 8.2-11.4 mm is contemplated.

We claim:

1. A cutting board comprising at least one image and at least one rubber contact point that contacts a surface on which the cutting board is disposed, and wherein the cutting board is made of plastic.

2. The cutting board of claim 1, wherein the cutting board is made of polyethylene or polypropylene.

3. The cutting board of claim 2, wherein the at least one image is generated by one or more of offset lithography, thermography, reprographics, screen printing, flexography, or gravure.

4. The cutting board of claim 2, further comprising a laminated surface.

5. The cutting board of claim 2, wherein the cutting board is asymmetrically shaped.

6. The cutting board of claim 4, wherein the laminated surface is attached to the cutting board by glue or epoxy.

7. The cutting board of claim 2, wherein the at least one rubber contact point is a non-slip perimeter.

8. The cutting board of claim 7, wherein the non-slip perimeter is made of one or more of a thermoplastic rubber, thermoplastic resin, thermoplastic elastomer, or thermoplastic vulcanite.

9. The cutting board of claim 8, wherein the image is made using offset lithography.

10. The cutting board of claim 9, further comprising a laminate over the image.

11. The cutting board of claim 10 wherein the laminate is made of acrylic.

12. The cutting board of claim 4, wherein the image is on the laminated surface.

13. The cutting board of claim 1 that is dishwasher safe.

14. A method of manufacturing a cutting board containing an image comprising:
manufacturing a base of the cutting board by press molding;
applying an image to a polypropylene sheet by offset printing or screen printing;
and adhering the polypropylene sheet containing the image to the base of the cutting board.

15. The method of claim 14, further comprising adding at least one rubber contact point wherein the at least one rubber contact point is one or more members selected from the group consisting of a rubber border, a partial rubber border, and an interior rubber contact point.

16. The method of claim 15, wherein the base of the cutting board is made of polypropylene or polyethylene.

17. The method of claim 16, wherein the press molding is performed on pellets of polypropylene or polyethylene.

18. The method of claim 14, wherein the press molding makes a depression channel that serves as a drip channel.

19. The method of claim 15, wherein the press molding makes a depression channel that serves as a drip channel.

20. The method of claim 14, wherein adhering the polypropylene sheet containing the image to the base of the cutting board is by epoxy, contact cement, or glue.

21. The method of claim 14, wherein the image is applied by screen printing or offset printing.

22. The method of claim 16, wherein the image is applied by screen printing or offset printing.
